(19) United States
(12) Patent Application Publication
(10) Pub. No.: US 2025/0186886 A1
(43) Pub. Date: Jun. 12, 2025

(54) NON-TRANSITORY COMPUTER-READABLE RECORDING MEDIUM, AND GAME SYSTEM

(71) Applicant: SQUARE ENIX CO., LTD., Tokyo (JP)

(72) Inventors: Momoka AONO, Tokyo (JP); Kazutoyo MAEHIRO, Tokyo (JP)

(73) Assignee: SQUARE ENIX CO., LTD., Tokyo (JP)

(21) Appl. No.: 18/970,273

(22) Filed: Dec. 5, 2024

(30) Foreign Application Priority Data
Dec. 6, 2023 (JP) 2023-206536

(51) Int. Cl. A63F 13/537; A63F 13/2145; A63F 13/52; A63F 13/533

(52) U.S. Cl. CPC A63F 13/537; A63F 13/52; A63F 13/2145; A63F 13/533

(57) ABSTRACT

The present invention provides a game program using a new user interface capable of confirming the progress of a game.

In a game in which content such as a person correlation diagram or a world emotion diagram updated with the progress of the game is displayed, the in-game time is changed by specifying the position of a slider indicating the in-game time, and the content after the change is displayed.

### CROSS REFERENCE TO RELATED APPLICATION(S)

The present disclosure claims priority to Japanese Patent Application No. 2023-206536, filed on Dec. 6, 2023, the disclosure of which is expressly incorporated herein by reference in its entirety for any purpose.

### BACKGROUND

The present disclosure relates to a non-transitory computer-readable recording medium and a game system.

Conventionally, there has been a game in which a log or a replay is displayed in order to progress the game and confirm a history.

### SUMMARY

The conventional information display simply displays text or reproduces the play content, and does not feel interesting in the game.

An object of at least one embodiment of the present invention is to provide a game program using a new user interface capable of confirming the progress of a game.

According to a non-limiting aspect, a game program according to the present invention is a game program for causing a server device to realize a function of controlling progress of a game, wherein a screen of the game includes a user interface capable of accepting a slide operation from a user, and a content storage means for storing content in the server device in association with an in-game time during which the content can be displayed, a game program for realizing content display means for displaying content corresponding to a position designated by a user operation on the user interface.

According to a non-limiting aspect of the present invention, there is provided a game system including a server device and a client terminal device, which are capable of communicating with each other via a communication network, and which controls progress of a game in accordance with an operation of a user, wherein a screen of the game includes a user interface capable of receiving a slide operation from the user, and the game system includes content storage means for storing content in association with an in-game time during which the content can be displayed, a game system including content display means for displaying content corresponding to a position designated by a user's operation on the user interface.

According to a non-limiting aspect, a game program according to the present invention is a game program for causing a computer device to realize a function of controlling progress of a game, wherein a screen of the game includes a user interface capable of accepting a slide operation from a user, and a content storage means for storing content in the computer device in association with an in-game time during which content can be displayed, a game program for realizing content display means for displaying content corresponding to a position designated by a user operation on the user interface.

One or more deficiencies are solved by embodiments of the present invention.

### BRIEF DESCRIPTION OF THE DRAWINGS

FIG. 1 is a block diagram showing a configuration of a system corresponding to at least one embodiment of the present invention.

FIG. 2 is a block diagram showing a configuration of a system corresponding to at least one embodiment of the present invention.

FIG. 3 is a flowchart related to an execution process corresponding to at least one embodiment of the present invention.

FIG. 4 is a diagram illustrating a content display screen corresponding to at least one embodiment of the present invention.

FIG. 5 is a diagram illustrating a content master table corresponding to at least one embodiment of the present invention.

FIGS. 6A-6C each are a diagram illustrating a difference in content display screen when a slider is moved, corresponding to at least one embodiment of the present invention.

FIGS. 7A-7B each are a diagram illustrating a change in a display mode of a slide bar corresponding to at least one embodiment of the present invention.

FIG. 8 is a diagram illustrating a content display screen corresponding to at least one embodiment of the present invention.

FIG. 9 is a block diagram showing a configuration of a system corresponding to at least one embodiment of the present invention.

FIGS. 10A-10B each are a diagram illustrating a content display screen in each mode corresponding to at least one embodiment of the present invention.

### DESCRIPTION OF EMBODIMENTS

Hereinafter, embodiments of the present invention will be described with reference to the accompanying drawings. Hereinafter, the description of the effects is one aspect of the effects of the embodiment of the present invention and is not limited to those described here. In addition, the order of each process included in the flowchart described below is unequal as long as no contradiction or mismatch occurs in the process contents.

### First Embodiment

An outline of a first embodiment of the present invention will be described. Hereinafter, as a first embodiment, a game system (hereinafter, also referred to as a system) which includes a server device and a client terminal device capable of communicating via a communication network and controls progress of a game in accordance with an operation of a user will be described as an example.

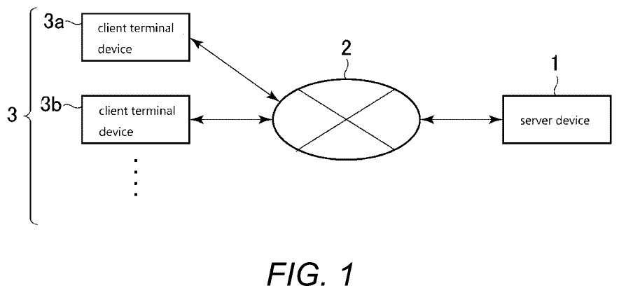

FIG. 1 is a block diagram showing a configuration of a system corresponding to at least one embodiment of the present invention. As illustrated, the system includes a plurality of client terminals 3 (client terminals 3a, 3b, . . . , hereinafter also referred to as terminal devices) operated by a plurality of users (users A, B, . . . ), a communication network 2, and a server device 1. The terminal device 3 is connected to the server device 1 via the communication network 2. The terminal device 3 and the server device 1 may not be always connected to each other, and may be connected to each other as necessary.

The server apparatus 1 includes at least a control unit, a RAM, a storage unit, and a communication interface, which are connected to each other by an internal bus. The controller may comprise an internal timer. The communication interface may also be used to synchronize with an external server. As a result, the actual time can be acquired.

The terminal device 3 includes, for example, a control unit, a RAM, a storage unit, a sound processing unit, a graphics processing unit, a communication interface, and an interface unit, which are connected to each other by an internal bus. The graphics processing unit is connected to the display unit. The display unit may include a display screen and a touch input unit that receives an input by a player's contact with the display unit.

The touch input unit may be, for example, a touch input unit that can detect a contact position using any method such as a resistive film method, a capacitive method, an ultrasonic surface acoustic wave method, an optical method, or an electromagnetic induction method used in a touch panel, and any method may be used as long as an operation can be recognized by a touch operation of a player. This is a device capable of detecting the position of a finger or the like when an operation such as pressing or moving the upper surface of the touch input unit with a finger, a stylus, or the like is performed.

An external memory (for example, an SD card or the like) may be connected to the interface unit. Data read from the external memory is loaded into the RAM, and arithmetic processing is executed by the control unit.

The communication interface can be connected to a communication network wirelessly or by wire, and can receive data via the communication network. The data received via the communication interface is loaded into the RAM in the same manner as the data read from the external memory, and arithmetic processing is performed by the control unit.

The terminal device 3 may include a sensor such as a proximity sensor, an infrared sensor, a gyro sensor, or an acceleration sensor. The terminal device 3 may include an imaging unit that includes a lens and captures an image via the lens. Further, the terminal device 3 may be a wearable terminal device.

### Game Summary

Next, an outline of a game assumed in the first embodiment of the present invention will be described. In the first embodiment, as an example, a game in which content displayed in a game is stored in association with an in-game time is exemplified. More specifically, the game is a game in which battles among a plurality of countries and vigors, attacks by the military, pressure control, and competitions are performed in accordance with the play result of the player (user).

### Functional Description

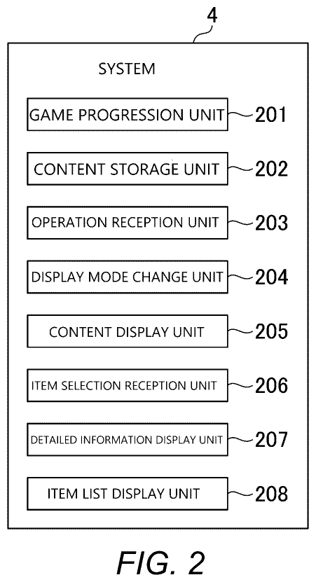

The functions of the system 4 will be described. FIG. 2 is a block diagram showing a configuration of a system corresponding to at least one of the embodiments of the present invention.

The system 4 may include a game progression unit 201, a content storage unit 202, an operation reception unit 203, a display mode change unit 204, a content display unit 205, an item selection reception unit 206, a detailed information display unit 207, and an item list display unit 208.

The game progression unit 201 has a function of progressing the video game. The content storage unit 202 has a function of storing content in association with an in-game time during which content can be displayed.

The operation receiving unit 203 has a function of receiving a user's operation. It is preferable that the operation receiving unit 203 determines and receives the type of the operation. Examples of the operation type include a button pressing operation, a screen touch operation, a mouse drag operation, and a slide operation of a touch screen.

The display mode changing unit 204 has a function of changing the display mode of the user interface according to the progress of the game. The user interface will be described later.

The content display unit 205 has a function of displaying content corresponding to a designated position by a user's operation on a user interface received by the operation receiving unit 203.

The item selection receiving unit 206 has a function of receiving selection of an item included in the content displayed by the content display unit 205 by the user's operation received by the operation receiving unit 203.

The detailed information display unit 207 has a function of displaying detailed information of an item selected by the item selection receiving unit 206.

The item list display unit 208 has a function of displaying a list of selectable items included in the content displayed by the content display unit 205.

### Execution Process Flow

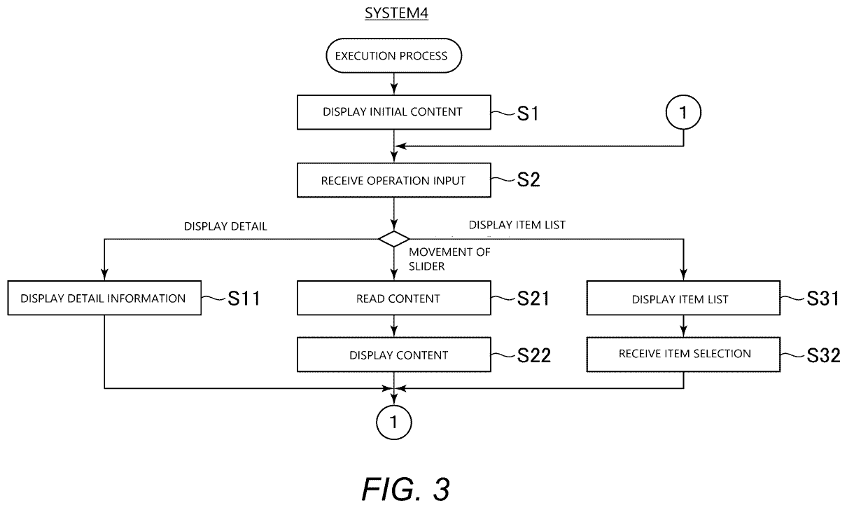

Next, an execution process in the system will be described. FIG. 3 is a flowchart related to an execution process corresponding to at least one of the embodiments of the present invention.

First, the system 4 performs initial display of a content display screen (step S1). The content display screen may be displayed when the content display menu is selected based on an operation of the user during execution of the game program. In step S1, the main character may be set as a selected item.

### Content Display Screen

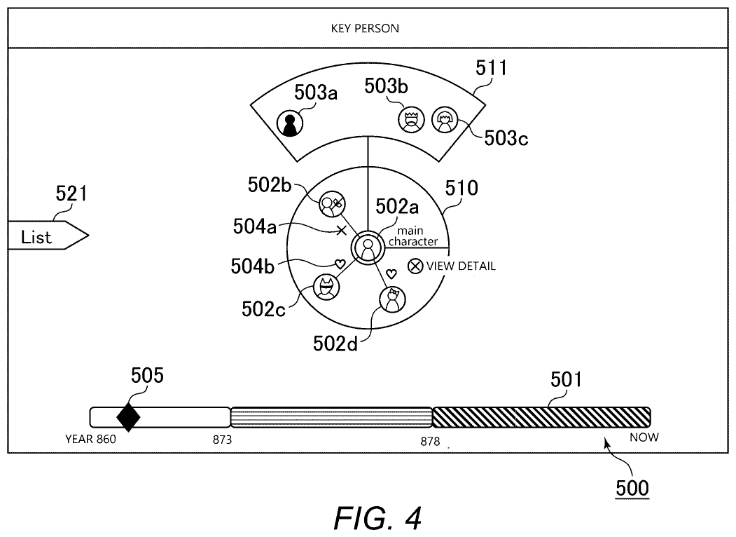

A content display screen to be displayed will be described. FIG. 4 is a diagram illustrating a content display screen corresponding to at least one of the embodiments of the present invention. As one example, the content display screen 500 may be a correlation diagram of characters appearing in the game, which is different from the game progress screen. Hereinafter, the character correlation diagram will be described, but the present invention is not limited thereto.

On the content display screen 500, as an example, a person correlation diagram related to the character 502a that is the main character can be displayed. On the content display screen 500, a group 510 to which the main character 502a belongs can be visually displayed. In addition, other characters 502b, 502c, and 502d belonging to the group 510 may be displayed.

Further, symbols 504a and 504b representing the relationship between the other characters 502b, 502c, and 502d and the main character 502a may be displayed. Symbol 504a may represent an enemy relationship and symbol 504b may represent a friend relationship. The symbol 504 may be displayed based on a relationship centered on the item selected by the user.

The symbol 504 may be predetermined in the in-game time, or may be determined based on a parameter that changes from moment to moment according to the play content of the user.

On the content display screen 500, a group 511 related to the main character 502a, which is different from the group to which the main character 502a belongs, can be displayed. In addition, other characters 503a, 503b, and 503c belonging to the group 511 may be displayed. The symbol 504 may be displayed for all characters, or may be displayed only in the group to which the main character 502a belongs.

A (slide) bar 501 representing the in-game time may be displayed on the content display screen 500. The left end of the bar 501 may represent the past and the right end may represent the present. The right end of the bar 501 may be a future time.

In a case where the right end of the bar 501 is a future in-game time, processing such as hiding the content in which the progress of the game has not reached may be performed.

The position of the slider 505 may be changed based on an operation from the user. Slider 505 may move along bar 501. The content displayed on the content display screen 500 may display content corresponding to the position of the slider 505. In the example shown in FIG. 3, the content corresponding to the in-game time from 860 to 873 is displayed.

The slider 505 may be slidable to a position designated by the user. A break may be provided according to the progress of the game, and the slider 505 may be controlled to stop at the break.

The characters 502 and 503 displayed on the content display screen 500 may be selectable items. Although the main character 502a is selected in the initial setting, another item may be selected in accordance with the operation of the user. Furthermore, an item list display button 521 for displaying an item list may be displayed on the content display screen 500. As shown in FIG. 4, the display may be controlled so that the selected character is displayed near the center of the screen. In addition, switching may be possible in order to display another correlation diagram.

A button for displaying detailed information of the selected item may be displayed. As shown in the figure, an item for displaying detailed information may be displayed in the vicinity of the selected item, such as “see in detail.”

When the initial display is performed in step S1, for example, the system 4 may control the slider 505 to be set at a position corresponding to the progress of the game.

Return to the flowchart of FIG. 3. The system 4 receives an operation from the user (step S2). Examples of the operation to be accepted include selection of an item included in the displayed content, movement of a slider, pressing of a detailed information display button, pressing of an item list display button, and the like.

When the received operation is an operation for instructing “detailed display”, the system 4 displays detailed information of the item selected on the content display screen (step S11). Thereafter, the system 4 waits until an operation from the user is received (step S2).

When the accepted operation is an operation for instructing “movement of slider”, the system 4 reads the content corresponding to the position of the slider after the movement (step S21), and displays the content (step S22). Thereafter, the system 4 waits until an operation from the user is received (step S2). For example, a content master table may be used to read content.

### Content Master Table

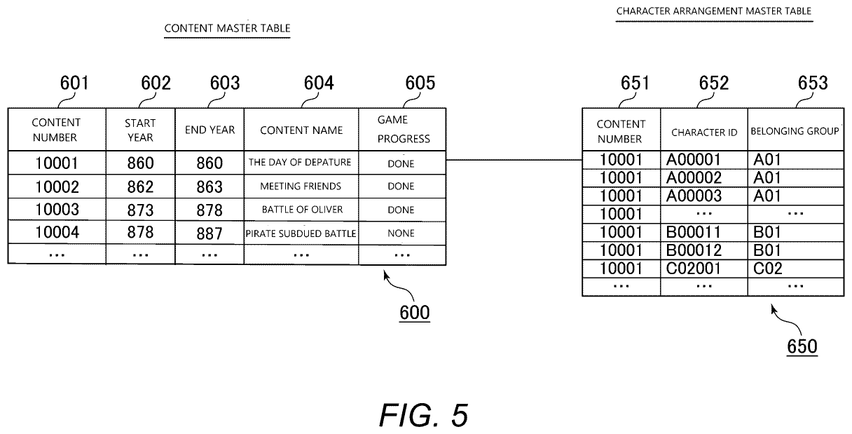

FIG. 5 is a diagram illustrating a content master table corresponding to at least one embodiment of the present invention. The content master table 600 may store a start year 602 of occurrence of content, an end year 603 of ending the content, a content name 604, and a game progress 605 indicating whether or not the progress of the game has reached the content, in association with the content number 601.

The system 4 displays the contents of the content number 601 included in the in-game time designated in the initial display or the in-game time designated by the user with the slider between the start year 602 and the end year 603 on the content display screen.

When content is displayed on the content display screen, a character arrangement master table 650 may be used to determine which position of the content display screen the character is arranged at. The content master table 600 and the character arrangement master table 650 shown in FIG. 5 can be combined using the content number 601 and the content number 651 as keys.

The character arrangement master table 650 may store a character ID 652 and an affiliated group 653 in association with a content number 651. The belonging group 653 is information indicating the groups 510 and 511 illustrated in FIG. 4. The characters may be arranged to be included in the belonging group 653.

It should be noted that the method described above is one example and is not limited to what has been described. For example, although the start year 602 and the end year 603 are described, they may be set in units of more detailed months and dates. The position coordinates of the slider 505 may be stored in the content master table 600. Further, a master data table for separately setting display conditions of items may be prepared.

In addition, in the character arrangement master table 650, instead of specifying only the belonging group 653, the position coordinates to be arranged on the content screen may be stored.

The data structure of the master data table shown in FIG. 5 can be adopted in a range without contradiction in the map display of the world situation as another example described later. That is, although the character arrangement master table is described as a name, not only characters but also cities, lands where events occur, and other elements constituting content may be stored as selectable items.

### Difference in Content Display at the Time of Slider Movement

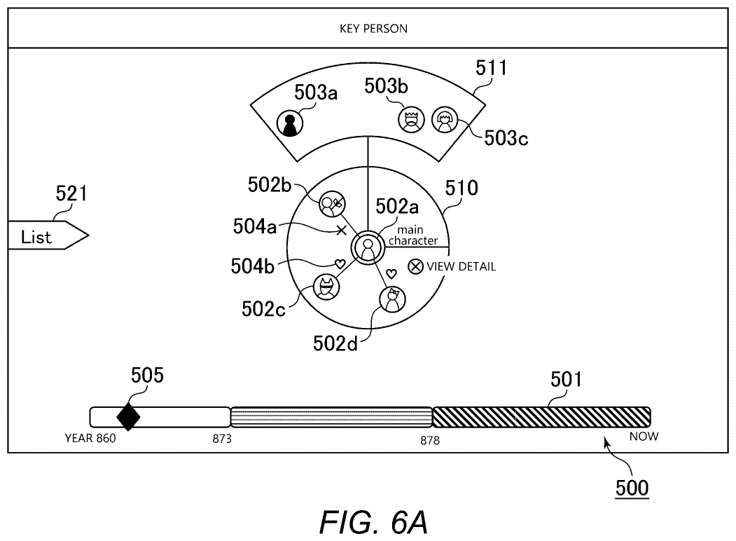

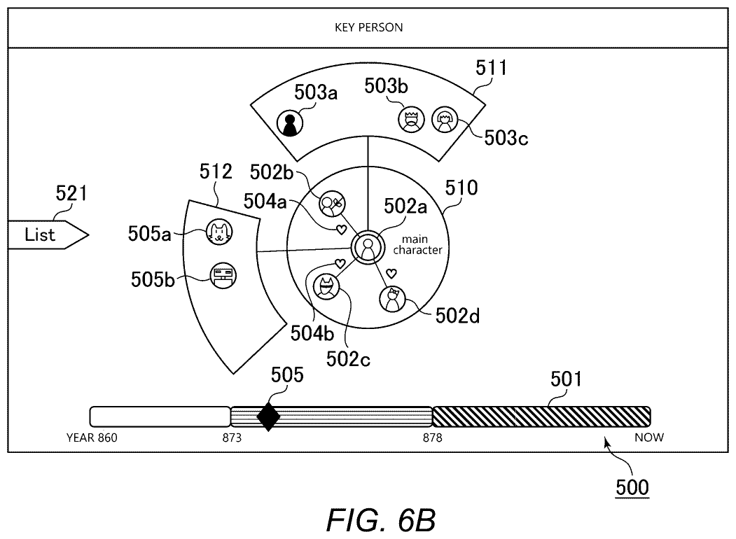

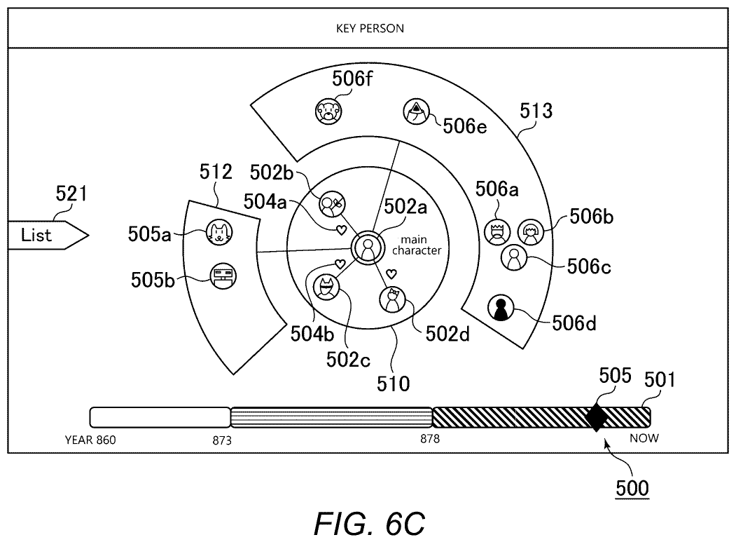

The difference in content display when the user moves the slider will be described. FIGS. 6A to 6C each are a diagram illustrating a difference in content display screen when a slider is moved, corresponding to at least one of the embodiments of the present invention.

FIG. 6A is the same as FIG. 4, and in the example shown in FIG. 3, contents corresponding to the in-game time from 860 to 873 are displayed.

FIG. 6B shows content corresponding to the in-game time from 873 to 878. A group 512 not shown in FIG. 6A appears, or a symbol 504a indicating the relationship between the main character 502a and the character 502b changes from a cross mark to a heart mark. This is a content changed in accordance with the progress of the game.

FIG. 6C shows contents corresponding to the in-game time of 878 years or later. The group 511 existing in FIGS. 6A and 6B disappears, and a new group 513 is added. In this way, the content to be displayed can be changed according to the progress of the game. The user can select the newly added item 506 (characters 506a-506f), and the system 4 displays detailed information of each item or displays the relationship viewed from each item as a symbol 504.

If the operation accepted in step S2 of the flowchart of FIG. 3 is an operation for instructing “display item list”, the system 4 displays the item list (step S31) and accepts selection of an item from the user (step S32). At this time, the system 4 may perform control to display the selected item so as to be located near the center of the content display screen. Thereafter, the system 4 waits until an operation from the user is received (step S2).

Although the item list is not shown, the item list may be displayed in a general list format, or may be displayed in a visually easily understandable format with icons of selectable items attached thereto.

### Display Mode Change

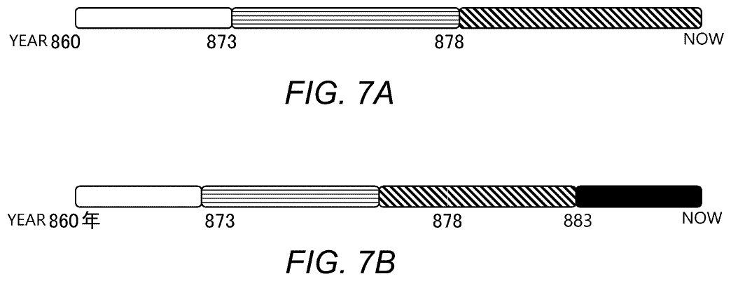

The display mode of the slide bar 501 shown in FIG. 4 and the like can be changed according to the progress of the game. FIGS. 7A-7B each are a diagram illustrating a change in a display mode of a slide bar corresponding to at least one of the embodiments of the present invention.

FIG. 7A illustrates a bar 501 illustrated in FIGS. 4, 6, and the like. On the other hand, FIG. 7B is an example of a bar 501 that can be displayed in a situation in which the game is advanced more than in FIG. 7A. By the display mode changing unit 204 of the system 4, the amount of the in-game time exceeding 883 years can be added to the right side of the bar. The added portions are preferably visually distinguished. Examples of visually recognizable include changing a color, providing a blinking effect, providing an additional animation, and the like.

In the above example, the bar 501 is displayed distinguished by the in-game time, but the embodiment of the present invention is not limited thereto. For example, each time the slider 505 is slid, the content to be displayed may be designed to be gradually changed in accordance with the content that has progressed in the past in the game.

Although the correlation diagram of persons has been described in the above example, the embodiment of the present invention is not limited thereto. For example, it may represent the vigilance of a national vigilance diagram in a game, or may represent a military situation of a military to which the game belongs.

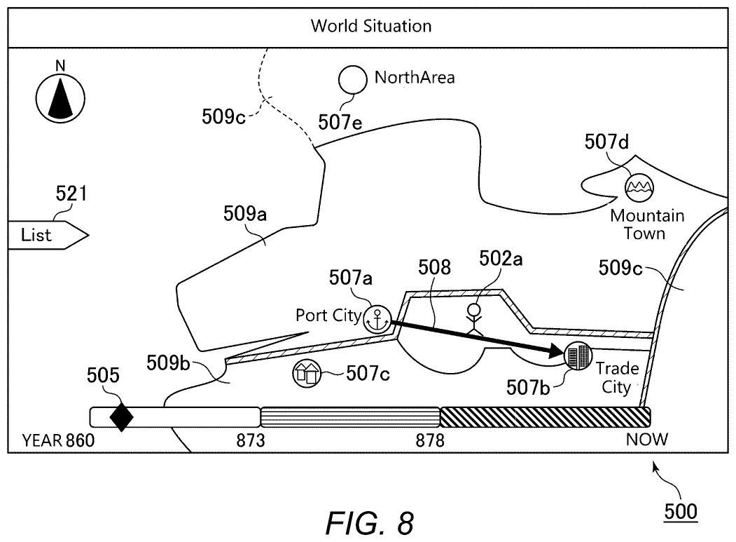

FIG. 8 is a diagram illustrating a content display screen corresponding to at least one of the embodiments of the present invention. In the content screen 500, the position of a plurality of cities, ships, and military contained in the content may be displayed as well as the momentum diagrams of the three groups at the predetermined positions of the slider 505. As an example, the momentums 509a, 509b, and 509c are present, and for the momentum 509c unknown in the progress of the game, a distinguishable expression may be used, such as displaying a region with a dotted line or not displaying a line until it is clearly shown.

In the time period of FIG. 8, arrow 508 may indicate that main character 502a has moved from location 507a to trade city 507b. In this way, the movement of a person, military or the like may be displayed on the map. When the item list display button 521 is pressed, a list of items selectable by the user included in the content can be displayed in the same manner as the display of the person correlation diagram.

In the above example, as an example of the content display screen 500, the person correlation diagram related to the character 502a which is the main character can be displayed, but the present disclosure is not limited thereto. For example, a person correlation diagram between characters that are not the main character may be displayed. There may be a plurality of modes in the person correlation diagram that can be displayed, and the modes may be switchable by an operation of the user.

In the above example, detailed information of an item can be displayed, but the embodiment of the present invention is not limited thereto. For example, when little information is obtained in the play content of the user, the detailed information may not be displayed.

In the above example, the slider 505 can be designated at an arbitrary position by the user, but the embodiment of the present invention is not limited thereto. For example, control may be performed so that the slider stops only at a place where content display is possible.

In the above example, the server device is used, but the embodiment of the present invention is not limited thereto. For example, a distributed ledger used in blockchain technology may be used instead of the storage of the server device.

In the above example, the processing is executed in the system, but the present invention is not limited thereto. For example, it does not prevent the design from being appropriately changed so that the server device or the client device executes the process.

In the above example, the game program is exemplified, but the present invention is not limited thereto. For example, it may be incorporated into a program deployed in a metaverse service, or may be applied to AR, VR, or the like.

As one aspect of the first embodiment, it is possible to provide a game program using a new user interface capable of confirming the progress of a game.

In the first embodiment, the “client terminal” refers to, for example, a stationary game machine, a portable game machine, a wearable terminal, a desktop or notebook personal computer, a tablet computer, or a PDA, and may be a portable terminal such as a smartphone having a touch panel sensor on a display screen. The “server device” refers to, for example, a device that executes processing in response to a request from a terminal device.

The “content” is, for example, a content realized by a program, and more specifically, refers to an event, an image, a moving image, a sound, or the like included in a game program.

### Second Embodiment

In a second embodiment of the present invention, a game program executed in a computer device having a display unit will be described. The configuration of the program according to the second embodiment can adopt a block diagram showing the configuration of the functions of the system shown in FIG. 2 within a necessary range.

### Third Embodiment

Hereinafter, as a third embodiment, a game system (hereinafter, also referred to as a system) that includes a server device and a client terminal device that can communicate with each other via a communication network and controls the progress of a game in accordance with an operation of a user will be described as an example. The configuration of the system can adopt the contents shown in FIG. 1 within a necessary range. The configurations of the server device 1 and the terminal device 3 can adopt the contents shown in the first embodiment within a necessary range.

### Game Summary

An example of the game assumed in the third embodiment of the present invention is a game in which content displayed in the game is stored in association with an in-game time. More specifically, the game is a game in which battles among a plurality of countries and vigors, attacks by the military, pressure control, and competitions are performed in accordance with the play result of the player (user). In the third embodiment, the content displayed in the game may be switched according to the operation of the user.

### Functional Description

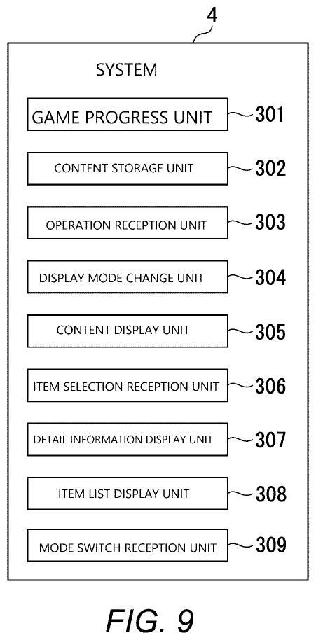

The functions of the system 4 will be described. FIG. 9 is a block diagram showing a configuration of a system corresponding to at least one of the embodiments of the present invention.

The system 4 may include a game progression unit 301, a content storage unit 302, an operation reception unit 303, a display mode change unit 304, a content display unit 305, an item selection reception unit 306, a detailed information display unit 307, an item list display unit 308, and a mode switching reception unit 309.

The game progression unit 301 has a function of progressing the video game. The content storage unit 302 has a function of storing content in association with an in-game time during which content can be displayed.

The operation receiving unit 303 has a function of receiving a user's operation. It is preferable that the operation receiving unit 303 determines and receives the type of the operation. Examples of the operation type include a button pressing operation, a screen touch operation, a mouse drag operation, and a slide operation of a touch screen.

The display mode changing unit 304 has a function of changing the display mode of the user interface according to the progress of the game. The content display unit 305 has a function of displaying content corresponding to a designated position by a user's operation on a user interface received by the operation receiving unit 303.

The item selection receiving unit 306 has a function of receiving selection of an item included in the content displayed by the content display unit 305 by the user's operation received by the operation receiving unit 303.

The detailed information display unit 307 has a function of displaying detailed information of an item selected by the item selection receiving unit 306. The item list display unit 308 has a function of displaying a list of selectable items included in the content displayed by the content display unit 305.

The mode switching receiving unit 309 has a function of receiving an operation for switching the mode from the user. The mode switching will be described later.

### Execution Process

As the execution processing in the system 4, the contents of the flowchart related to the execution processing shown in FIG. 3 can be adopted within a necessary range.

### Content Display Screen

Regarding the content display screen to be displayed, the contents of the content display screen shown in FIG. 4 can be adopted within a necessary range.

A (slide) bar 501 representing the in-game time may be displayed on the content display screen 500. The left end of the bar 501 may represent the past and the right end may represent the present. The right end of the bar 501 may be a future time. In a case where the right end of the bar 501 is a future in-game time, processing such as hiding the content in which the progress of the game has not reached may be performed.

There may be a plurality of bars 501. For example, each bar may correspond to an individual story such as a quest included in the content. The time series of each story is independent, and it is preferable that the time series is closed in the same bar 501. Any of the bars 501 may be slid to represent the progress of the quest.

The position of the slider 505 may be changed based on an operation from the user. Slider 505 may move along bar 501. The content displayed on the content display screen 500 may display content corresponding to the position of the slider 505. In the example shown in FIG. 3, the content corresponding to the in-game time from 860 to 873 is displayed.

The slider 505 may be slidable to a position designated by the user. A break may be provided according to the progress of the game, and the slider 505 may be controlled to stop at the break. Based on the contents shown in FIG. 6A to FIG. 6C, the content display may transition when the user moves the slider. In addition, the position of the slider 505 may be controlled to be changed in accordance with the progress of the game of the user. The display mode of the slide bar can be changed by adopting the contents shown in FIG. 7 within a necessary range.

### Mode Switching

In the third embodiment, the mode may be designed to be switchable based on a predetermined operation from the user. As an example, the mode is switched between a first mode (an objective mode) in which a human relationship in a predetermined in-game time is objectively viewed from a state of game progress and a second mode (a subjective mode) in which a feeling that a character selected by the user has felt at that moment is expressed.

The content display unit 305 displays content based on the mode corresponding to the position designated by the user's operation on the user interface received by the operation receiving unit 303.

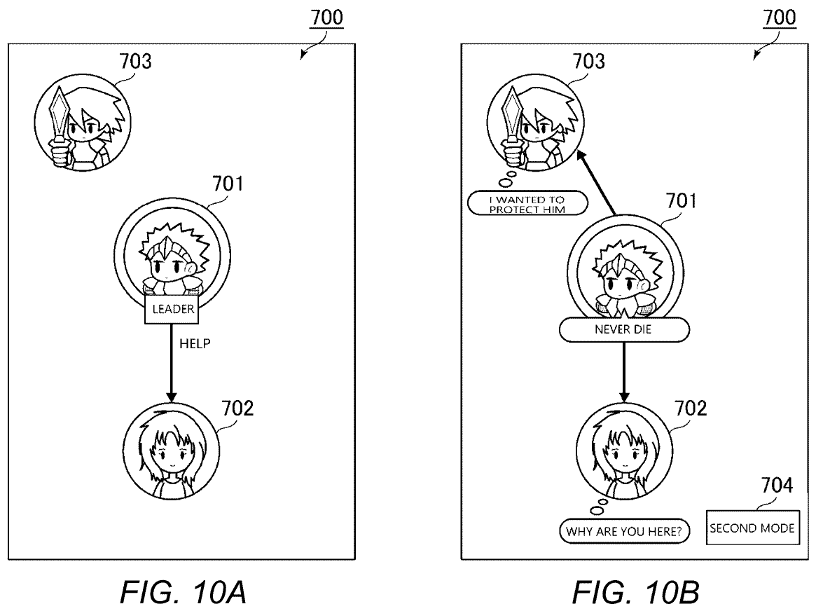

The second mode (subjective mode) aims at displaying the “relationship” of the selected line of sight of the character. FIGS. 10A-10 each are a diagram illustrating a content display screen corresponding to at least one of the embodiments of the present invention. On the content display screen 700, as an example, a person correlation diagram related to an item 701 representing a character (hereinafter, also referred to as a character) can be displayed. The character 701 is an item selected by the user's operation.

On the content display screen 500, a character 701 as a selected item and items 702 and 703 representing other characters (hereinafter, also referred to as other characters) can be displayed. Hereinafter, the first mode (objective mode) and the second mode (subjective mode) will be specifically described.

FIG. 10A is a diagram illustrating a content display screen in the first mode (objective mode) corresponding to at least one of the embodiments of the present invention. In the objective mode, text indicating the relationship between the character 701 and the other characters 702 and 703 (in the figure, “aid”) may be displayed on the content display screen 700. The arrow extending from the character 701 to the character 702 indicates that the subject of the action is the character 701 and the target of the action is the character 702.

In the objective mode, information may be displayed that objectively explains the scenario of the game in which the character 701 is a soldier and the character 701 has helped the character 702. If the user plays the game, information that can be reminded is provided.

FIG. 10B is a diagram illustrating a content display screen in the second mode (subjective mode) corresponding to at least one of the embodiments of the present invention. A display 704 for recognizing the second mode may be displayed on the content display screen 700.

In FIGS. 10A and 10B, (slide) bars representing the in-game time are not shown, but are assumed to be in the same in-game time.

In the subjective mode, the thought, emotion, and emotion of the character 701 that were not displayed in the objective mode may be displayed. For example, it is assumed that the character 701 in a certain in-game time is considered to be “dead here”. In addition, it is possible to indicate that the character 702 has a question of “what is?”. Further, in the objective mode, it can be seen that the character 703 in which the relationship is not particularly displayed has a feeling of “warranted”.

As described above, in the objective mode, it is possible to express the relationship that appears in the time course (the progress of the story). On the other hand, in the subjective mode, in addition to the relationship drawn by the progress of the story, which is seen by changing the character to be selected, the relationship that cannot be expressed by the progress of the story can also be represented.

In the above example, switching between the first mode and the second mode has been described, but the present invention is not limited thereto. A plurality of modes may exist, and a mode may be added every time a predetermined condition is satisfied.

In the above example, the condition for switching the mode is not described, but the present invention is not limited thereto. For example, in a case where there is a record in which the game is cleared once, that is, in a case where the user replays the game for the second time or later, the mode may be switchable. At this time, the progress degree may be rewound only in the situation of the content being played, or the progress degree may be confirmed in all situations where the situation of the other content is cleared. In addition, control may be performed so that only the information of the character encountered in the predetermined quest included in the content is rewound.

In the above example, the item is selected and the mode is switched. The mode may be switched without selecting an item, and the mode may be switched by a user's operation, and the mode of implementation may be any mode as long as the effect is achieved.

In the above example, the person correlation diagram can be displayed as an example of the content display screen, but the present disclosure is not limited thereto. For example, a person correlation diagram between characters that are not the main character may be displayed.

In the above example, the slider can be designated to any position of the user, but the embodiment of the present invention is not limited thereto. For example, control may be performed so that the slider stops only at a place where content display is possible.

In the above example, the server device is used, but the embodiment of the present invention is not limited thereto. For example, a distributed ledger used in blockchain technology may be used instead of the storage of the server device.

In the above example, the processing is executed in the system, but the present invention is not limited thereto. For example, it does not prevent the design from being appropriately changed so that the server device or the client device executes the process.

In the above example, the game program is exemplified, but the present invention is not limited thereto. For example, it may be incorporated into a program deployed in a metaverse service, or may be applied to AR, VR, or the like.

As one aspect of the third embodiment, it is possible to provide a game program using a new user interface capable of confirming the progress of a game.

In the third embodiment, the contents shown in the first embodiment can be adopted as “client terminal”, “server device”, and “contents”, respectively, within a necessary range.

While the present invention has been particularly shown and described with reference to exemplary embodiments thereof, it will be understood by those skilled in the art that various changes in form and details may be made therein without departing from the spirit and scope of the invention as defined by the appended claims.

### INDUSTRIAL APPLICABILITY

According to one embodiment of the present invention, it is useful to provide a new user interface capable of confirming the progress of a game.

1. A non-transitory computer-readable recording medium having recorded thereon a game program for causing a server device to realize a function of controlling progress of a game, a screen of the game includes a user interface capable of receiving a slide operation from a user, the game program causing the server device to perform functions comprising:
storing the content in association with an in-game time during which the content can be displayed, and
displaying content corresponding to a position designated by a user's operation on the user interface.

2. The non-transitory computer-readable recording medium according to claim 1, further comprising:
changing the display mode of the user interface according to the progress of the game.

3. The non-transitory computer-readable recording medium according to claim 2,
wherein the changing the display mode function changes a portion of the user interface that is operable by the user in accordance with the progress of the game can be visually recognized.

4. The non-transitory computer-readable recording medium according to claim 1 or 2, the game program causing the server device to perform functions further comprising:
receiving instruction to switch mode of content to be displayed,
wherein the content display function displays content corresponding to the accepted mode.

5. A game system that includes a server device and a client terminal device, the server device and the client terminal device being capable of communicating with each other via a communication network, the game system controlling progress of a game according to an operation of a user, a screen of the game includes a user interface capable of receiving a slide operation from a user, the game system comprising:
storing the content in association with an in-game time during which the content can be displayed; and,
displaying content corresponding to a position designated by a user's operation on the user interface.

6. A non-transitory computer-readable storage medium having recorded thereon a game program for causing a computer device to implement a function of controlling progress of a game, a screen of the game includes a user interface capable of receiving a slide operation from a user, the game program causing the computer device to perform functions comprising:
storing the content in association with an in-game time during which the content can be displayed, and
displaying content corresponding to a position designated by a user's operation on the user interface.
